(19) United States
(12) Patent Application Publication
(10) Pub. No.: US 2025/0329093 A1
(43) Pub. Date: Oct. 23, 2025

(54) GENERATION METHOD AND APPARATUS FOR IMAGE WITH THREE-DIMENSIONAL EFFECT, AND ELECTRONIC DEVICE AND STORAGE MEDIUM

(71) Applicant: Beijing Bytedance Network Technology Co., Ltd., Shijingshan District, Beijing (CN)

(72) Inventors: Weihong Zeng, Beijing (CN); Xu Wang, Beijing (CN)

(21) Appl. No.: 18/869,132

(22) PCT Filed: May 17, 2023
(86) PCT No.: PCT/CN2023/094792

§ 371 Date: Nov. 25, 2024

(30) Foreign Application Priority Data
May 25, 2022 (CN) 202210579466.6

(51) Int. Cl. G06T 13/40; G06T 15/00

(52) U.S. Cl. CPC G06T 13/40; G06T 15/005

(57) ABSTRACT

Provided in the present disclosure are a generation method and apparatus for an avatar with a three-dimensional effect, and an electronic device and a storage medium. The method for generating an avatar with a three-dimensional effect comprises: acquiring a target material, wherein the target material is divided into at least two layers; determining an occlusion relationship between the at least two layers and a virtual avatar; and rendering the target material and the virtual avatar according to the occlusion relationship, so as to generate the virtual avatar with a three-dimensional effect.

This application claims priority to Chinese Patent Application No. 202210579466.6, filed with the China National Intellectual Property Administration on May 25, 2022, which is incorporated herein by reference in its entirety.

### FIELD

The present disclosure relates to the field of computer technology, and for example, relates to a method and apparatus for generating an avatar with a three-dimensional effect, an electronic device, and a storage medium.

### BACKGROUND

In the related art, to render an avatar with a three-dimensional effect in an interface, three-dimensional data for the avatar typically needs to be first created. The related art at least has the defects that in some personalized avatar rendering scenarios, it takes a long time to create the three-dimensional data for the avatar and perform rendering, leading to poor real-time performance.

### SUMMARY

The present disclosure provides a method and apparatus for generating an avatar with a three-dimensional effect, an electronic device, and a storage medium, which can generate an avatar with a three-dimensional effect in real time without creating three-dimensional data for the avatar.

In a first aspect, the present disclosure provides a method for generating an avatar with a three-dimensional effect, including:
acquiring a target material, where the target material is divided into at least two layers;
determining an occlusion relationship between the at least two layers and a virtual avatar; and
rendering the target material and the virtual avatar based on the occlusion relationship to generate the virtual avatar with a three-dimensional effect.

In a second aspect, the present disclosure further provides an apparatus for generating an avatar with a three-dimensional effect, including:
a material acquisition module, configured to acquire a target material, where the target material is divided into at least two layers;
an occlusion relationship determination module, configured to determine an occlusion relationship between the at least two layers and a virtual avatar; and
a rendering module, configured to render the target material and the virtual avatar based on the occlusion relationship to generate the virtual avatar with a three-dimensional effect.

In a third aspect, the present disclosure further provides an electronic device. The electronic device includes:
one or more processors; and
a storage apparatus, configured to store one or more programs,
the one or more programs, when executed by the one or more processors, cause the one or more processors to implement the above method for generating an avatar with a three-dimensional effect.

In a fourth aspect, the present disclosure further provides a storage medium including computer executable instructions, where the computer executable instructions, when executed by a computer processor, are used to perform the above method for generating an avatar with a three-dimensional effect.

In a fifth aspect, the present disclosure further provides a computer program product, including a computer program embodied on a non-transitory computer-readable medium. The computer program includes program code used to perform the above method for generating an avatar with a three-dimensional effect.

### BRIEF DESCRIPTION OF THE DRAWINGS

FIG. 1 is a schematic flowchart of a method for generating an avatar with a three-dimensional effect according to an embodiment of the present disclosure;

FIG. 2 is a schematic diagram of determining an occlusion relationship in a method for generating an avatar with a three-dimensional effect according to an embodiment of the present disclosure;

FIG. 3 is a schematic diagram of determining an occlusion relationship in another method for generating an avatar with a three-dimensional effect according to an embodiment of the present disclosure;

FIG. 4 is a schematic flowchart of determining an occlusion relationship in a method for generating an avatar with a three-dimensional effect according to an embodiment of the present disclosure;

FIG. 5 is a schematic flowchart of another method for generating an avatar with a three-dimensional effect according to an embodiment of the present disclosure;

FIG. 6 a schematic diagram of a process for presenting a virtual avatar with a naked-eye three-dimensional (3D) effect in an interface in a method for generating an avatar with a three-dimensional effect according to an embodiment of the present disclosure;

FIG. 7 is a structural schematic diagram of an apparatus for generating an avatar with a three-dimensional effect according to an embodiment of the present disclosure; and

FIG. 8 is a structural schematic diagram of an electronic device according to an embodiment of the present disclosure.

### DETAILED DESCRIPTION OF EMBODIMENTS

The embodiments of the present disclosure will be described in more detail below with reference to the accompanying drawings. Although the accompanying drawings show some embodiments of the present disclosure, the present disclosure may be implemented in various forms, and these embodiments are provided for understanding the present disclosure. The accompanying drawings and the embodiments of the present disclosure are for exemplary purposes only.

A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

Concepts such as “first” and “second” mentioned in the present disclosure are only for distinguishing different apparatuses, modules, or units, and are not intended to limit the order or relation of interdependence of functions performed by these apparatuses, modules, or units.

Modifications such as “a” and “a plurality of” mentioned in the present disclosure are indicative rather than limiting, and those skilled in the art should understand that unless otherwise specified in the context, it should be interpreted as “one or more”.

The names of messages or information exchanged between a plurality of apparatuses in the implementations of the present disclosure are provided for illustrative purposes only, and are not used to limit the scope of these messages or information.

Before using the technical solutions disclosed in the embodiments of the present disclosure, a user shall be informed of the type, range of use, application scenarios, etc., of personal information involved in the present disclosure in an appropriate manner in accordance with the relevant laws and regulations, and the authorization shall be obtained from the user.

For example, in response to receiving an active request from a user, a prompt message is sent to the user to clearly inform the user that a requested operation will require access to and use of the personal information of the user. As such, the user can independently choose, based on the prompt message, whether to provide the personal information to software or hardware, such as an electronic device, an application, a server, or a storage medium, that performs operations of the technical solutions of the present disclosure.

As an implementation, in response to receiving an active request from a user, a manner for sending a prompt message to the user may be, for example, a pop-up window, in which the prompt message may be presented in text. Further, the pop-up window may also carry a selection control for the user to choose whether to “agree” or “disagree” to provide the personal information to the electronic device.

The above process for notifying the user and obtaining authorization from the user is only illustrative, which does not limit the implementations of the present disclosure, and other methods that comply with relevant laws and regulations may also be applied to the implementations of the present disclosure.

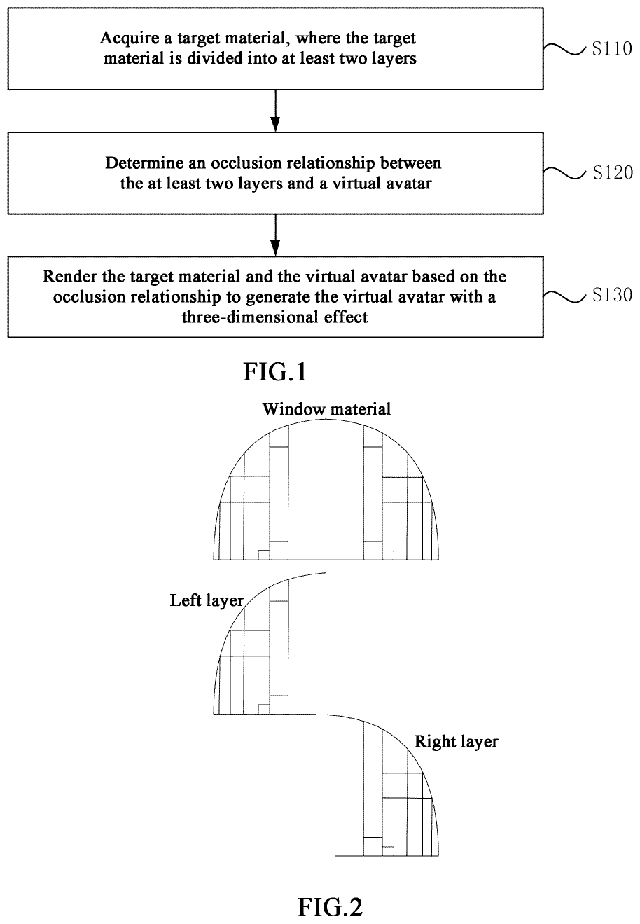

FIG. 1 is a schematic flowchart of a method for generating an avatar with a three-dimensional effect according to an embodiment of the present disclosure. Embodiment of the present disclosure is suitable for a case of generating a virtual avatar with a 3D effect, such as a case of generating a virtual avatar with a naked-eye 3D effect in real time. The method may be performed by an apparatus for generating an avatar with a three-dimensional effect. The apparatus may be implemented in a form of software and/or hardware, and may be configured in an electronic device, such as a mobile phone or a computer.

As shown in FIG. 1, the method for generating an avatar with a three-dimensional effect may include:
S110: Acquire target material, where the target material is divided into at least two layers.

In this embodiment of the present disclosure, at least one two-dimensional image material may be designed in advance, and each material may be divided into at least two layers during a design process.

When there is one pre-designed material, the material may be used as a target material. When there are a plurality of pre-designed materials, the target material may be determined based on at least one of the following: determining the target material from the plurality of pre-designed materials in response to a selection instruction input by a user; sorting the plurality of materials based on a sorting condition input by the user (e.g., a material theme, an update date, use popularity, and other conditions), and determining the top-ranked material as the target material; and using a default material among the plurality of materials as the target material, etc. In addition, other methods for determining the target material may also be applied herein, which are not listed exhaustively herein.

After the target material is determined, whether the target material has been downloaded locally may be determined. If the target material has been downloaded locally, the target material may be obtained locally; and if the target material has not been downloaded locally, the target material may be downloaded so as to be obtained.

S120: Determine an occlusion relationship between the at least two layers and a virtual avatar.

According to embodiments of the present disclosure, the method for generating a virtual avatar may include at least one of the following: generating a virtual avatar composed of a plurality of random parts in response to a one-click generation instruction input by the user; in response to an avatar editing instruction input by the user, generating a virtual avatar composed of a plurality of parts corresponding to the avatar editing instruction; generating a virtual avatar similar to a real object based on characteristics of the real object. The virtual avatar may be a two-dimensional avatar, or a quasi-three-dimensional avatar with a three-dimensional display effect generated by placing a plurality of two-dimensional parts at different depths.

The above-mentioned creation of the virtual avatar based on the editing instruction and the generation of the virtual avatar similar to a real image may both be considered as personalized avatar generation scenarios. The personalized avatar generation scenario may be understood as the virtual avatar being generated instantly before rendering, rather than being pre-generated. In these scenarios, compared with the related art that requires the generation of three-dimensional data for an avatar, generating the two-dimensional virtual avatar or the quasi-three-dimensional virtual avatar according to this embodiment may shorten the time consumed for avatar generation, which is beneficial for achieving fast and real-time avatar rendering.

The occlusion relationship between the at least two layers and the virtual avatar may include: some layers being above the virtual avatar, and some layers being below the virtual avatar. When a layer is above the virtual avatar, the layer may occlude the virtual object, thereby visually presenting an effect of the virtual avatar being behind the layer When a layer is below the virtual object, the virtual object may occlude the layer, thereby visually presenting an effect of the virtual avatar being in front of the layer. By placing some layers above the virtual object and some layers below the virtual object, a visual depth relationship may be constructed, thereby generating a naked-eye 3D effect after rendering the virtual object based on the occlusion relationship.

Determining an occlusion relationship between the at least two layers and the virtual avatar may include at least one of the following: determining the occlusion relationship between the at least two layers and the virtual object in response to an occlusion relationship determination instruction input by the user; determining the occlusion relationship between the at least two layers and the virtual avatar in real time based on an action performed by the virtual avatar; and determining the occlusion relationship between the at least two layers and the virtual avatar based on preset occlusion relationship identifiers for the at least two layers.

The occlusion relationship determination instruction may include an upper-lower layer sequence of the at least two layers and the virtual object. Based on the upper-lower layer sequence, the upper-lower layer occlusion relationship between the at least two layers and the virtual object may be determined.

The virtual object may perform a corresponding action in response to a driving instruction. For example, the virtual object may lean the head to the left in response to a “lean left” instruction input by the user. During a process that the virtual object dynamically performs the action, the occlusion relationship between the at least two layers and the virtual object may be determined in real time based on the performed action.

Exemplarily, FIG. 2 is a schematic diagram of determining an occlusion relationship in a method for generating an avatar with a three-dimensional effect according to an embodiment of the present disclosure. Referring to FIG. 2, the target material is a window material. The material may be divided into a left layer and a right layer, and the left layer and the right layer include a left window sash and a right window sash, respectively. When the virtual avatar leans the head to the left, the layer including the left window sash may be below the virtual avatar, and the layer including the right window sash may be above the virtual avatar. When the virtual avatar leans the head to the right, the layer including the right window sash may be below the virtual avatar, and the layer including the left window sash may be above the virtual avatar.

The process of determining the occlusion relationship based on the action performed by the virtual object may be understood as a process of determining the occlusion relationship while performing rendering. That is, the action of the virtual object may be rendered, meanwhile, the occlusion relationship of the at least two layers in the target material may be determined based on the action, and the target material and the virtual object are rendered based on the occlusion relationship. When the virtual object performs the action, the occlusion relationship between the at least two layers and the virtual object is determined in real time, thereby presenting a diversified naked-eye 3D effect, and improving user experience.

During the process of pre-designing the material, an occlusion relationship identifier is set for each layer in response to dividing the material into the at least two layers. The preset occlusion relationship identifiers may include, for example, a background identifier and a foreground identifier. The layer corresponding to the background identifier may be a layer below the virtual avatar, and the layer corresponding to the foreground identifier may be a layer above the virtual avatar. Correspondingly, the occlusion relationship between the at least two layers and the virtual object may be determined based on the preset occlusion relationship identifiers.

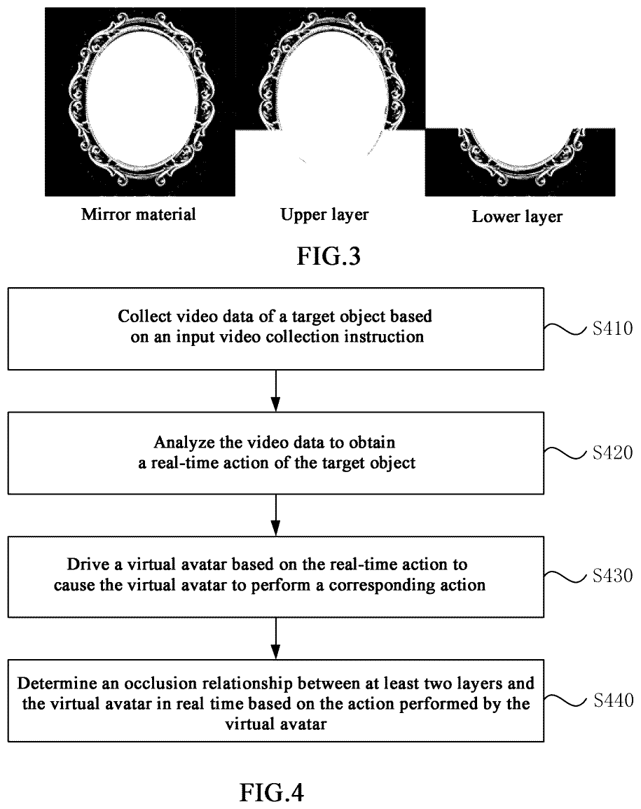

Exemplarily, FIG. 3 is a schematic diagram of determining an occlusion relationship in another method for generating an avatar with a three-dimensional effect according to an embodiment of the present disclosure. Referring to FIG. 3, the target material is a mirror material. The material may be divided into an upper layer and a lower layer, and preset occlusion relationship identifiers for the upper layer and the lower layer may be a background identifier and a foreground identifier, respectively. When the virtual avatar is rendered, the virtual avatar may be placed in front of the upper layer and behind the lower layer. By allowing the virtual avatar to occlude part of a mirror frame in the upper layer, a naked-eye 3D effect protruding from a mirror may be presented.

In this embodiment, by determining the occlusion relationship based on a diversified method, the avatar with the naked-eye 3D effect may be rendered more flexibly, thereby improving the user experience.

S130: Render the target material and the virtual avatar based on the occlusion relationship to generate the virtual avatar with a three-dimensional effect.

In this embodiment of the present disclosure, the at least two layers and the virtual avatar may be rendered based on the occlusion relationship between the at least two layers and the virtual avatar, visual depth relationships between the virtual object and different parts of the target material may be constructed, thereby making the virtual object have the naked-eye 3D effect. There is no need to create the three-dimensional data for the avatar in the process. By using a low-cost two-dimensional avatar, supplemented with some preset materials, the naked-eye 3D visual effect may be achieved, and the avatar with the three-dimensional effect may be generated in real time.

In some implementations, the target material includes a frame; and rendering the target material and the virtual avatar based on the occlusion relationship includes: rendering the virtual avatar in front of part of the frame. In these embodiments, the target material may include a mirror, a television, a window, a railing wall, and other materials including a frame. By rendering the virtual avatar in front of a part of the frame, the virtual avatar may occlude the part of the frame, thereby presenting a naked-eye 3D effect such as the virtual avatar protruding from the mirror, protruding from a television screen, protruding from the window, and protruding between two railings. There are a variety of gameplay options, thereby improving the user experience.

The technical solution of this embodiment of the present disclosure includes: acquiring a target material, where the target material may be divided into the at least two layers; determining an occlusion relationship between the at least two layers and a virtual avatar; and rendering the target material and the virtual avatar based on the occlusion relationship to generate the virtual avatar with a three-dimensional effect. The avatar with the naked-eye three-dimensional effect may be presented by determining the occlusion relationship between the at least two layers in the target material and the virtual object and rendering the target material and the virtual object based on the occlusion relationship. There is no need to create the three-dimensional data for the avatar in the process, satisfying a requirement for generating an avatar with the three-dimensional effect in real time.

This embodiment of the present disclosure may be combined with a plurality of solutions in the method for generating an avatar with a three-dimensional effect provided by the above embodiment. In the method for generating an avatar with a three-dimensional effect provided by this embodiment, steps for determining the occlusion relationship are described. By collecting actions of a target object and synchronously migrating the actions to a virtual avatar, the virtual avatar may perform a corresponding action, thereby improving interactivity with the virtual avatar and playability. Then, during a process that the virtual object performs the action, the occlusion relationship between the at least two layers and the virtual object may be determined in real time, thereby achieving a diversified naked-eye 3D effect, and improving the user experience.

FIG. 4 is a schematic flowchart of determining an occlusion relationship in a method for generating an avatar with a three-dimensional effect according to an embodiment of the present disclosure. Referring to FIG. 4, the process for determining the occlusion relationship in this embodiment may include:
S410: Collecting video data of a target object based on an input video collection instruction.

In response to receiving the video collection instruction input by the user, the video data of the target object may be collected by a video collection apparatus (e.g., one or more cameras). When there is only one object within a collection range of the video collection apparatus, the object may be considered as the target object. When there are a plurality of objects within the collection range, the target object may be focused on from the plurality of objects based on a focus instruction input by the user or by using other methods such as autofocus.

S420: Analyzing the video data to obtain a real-time action of the target object.

The video data may be analyzed by an open source action recognition model so as to obtain the real-time action of the target object. Alternatively, a plurality of feature points of the target object may be first recognized through an open source feature point recognition model, and the real-time action of the target object is determined by tracking positions of the feature points. In addition, other methods for obtaining the real-time action of the target object through video analysis may also be applied herein, which are not listed exhaustively herein.

S430: Drive the virtual avatar based on the real-time action to cause the virtual avatar to perform a corresponding action.

A driving instruction may be generated based on the real-time action, and the generated virtual avatar is driven through the driving instruction, such that the virtual avatar performs the corresponding action. The corresponding action may include an action that is the same as the real-time action of the target object, or may also include an action obtained after adding a certain effect to the action the same as the real-time action.

Because the virtual avatar may be the two-dimensional avatar or the quasi-three-dimensional avatar, the virtual avatar may be driven through an open source two-dimensional driving algorithm. By driving the virtual avatar based on the real-time action of the target object, interactivity of the virtual avatar can be improved, and playability is high.

In some implementations, in addition to analyzing the real-time action of the target object and synchronously migrating the real-time action to the virtual avatar, a real-time facial expression of the target object may also be analyzed, and the virtual avatar may be driven based on the real-time facial expression, such that the virtual avatar performs a corresponding expression, thereby improving the interactivity and the user experience.

S440: Determining an occlusion relationship between at least two layers and the virtual avatar in real time based on the action performed by the virtual avatar.

The process of real-time driving of the virtual avatar to perform the same action may be considered as the process of rendering the action of the virtual object. During the process of real-time driving of the virtual avatar to perform the action, the occlusion relationship between the at least two layers and the virtual avatar may be determined in real time based on the action performed by the virtual avatar. Then, the target material and the virtual object are rendered based on the occlusion relationship. The process may be considered as a process of determining the occlusion relationship while performing rendering. During a process that the virtual object performs the action, the occlusion relationship between the at least two layers and the virtual object is determined in real time, thereby presenting a diversified naked-eye 3D effect, and improving the user experience.

In a technical solution of this embodiment of the present disclosure, steps for determining the occlusion relationship are described. By collecting actions of the target object and synchronously migrating the actions to the virtual avatar, the virtual avatar may perform corresponding actions, thereby improving the interactivity of the virtual avatar and playability. Then, during a process that the virtual object performs the actions, the occlusion relationship between the at least two layers and the virtual object may be determined in real time, thereby achieving a diversified naked-eye 3D effect, and improving the user experience. The method for generating an avatar with a three-dimensional effect provided by this embodiment of the present disclosure and the method for generating an avatar with a three-dimensional effect provided by the above embodiment belong to the same concept, and for technical details not described in detail in this embodiment, reference may be made to the above embodiment. The same technical features have the same effects in this embodiment and the above embodiment.

This embodiment of the present disclosure may be combined with a plurality of solutions in the method for generating an avatar with a three-dimensional effect provided by the above embodiment. According to the method for generating an avatar with a three-dimensional effect provided by this embodiment, thousands of personalized virtual avatars may be created by performing attribute analysis on a plurality of parts of the target object. In addition, before generating the virtual avatar, a real image of the target object may be presented in the interface; and after the virtual avatar is generated, the virtual avatar exclusive to the real image may be presented through a transition effect, and the generation of the personalized avatar can improve the user experience.

FIG. 5 is a schematic flowchart of another method for generating an avatar with a three-dimensional effect according to an embodiment of the present disclosure. As shown in FIG. 5, the method for generating an avatar with a three-dimensional effect provided by this embodiment includes:
S511: Acquiring a target material, where the target material is divided into at least two layers.
S512: Collecting image data of a target object based on an input image collection instruction.

In response to receiving the image collection instruction input by the user, the image data of the target object may be collected by an image collection apparatus (e.g., one or more cameras). For the method for determining the target object, reference may be made to the method for collecting the video data of the target object.

S520: Rendering the target material and the image data.

There is no strict time sequence relationship between the step for acquiring the target material and the step for collecting the image data, and a time sequence may be determined based on business scenarios. For example, the user may first select the target material in a material selection interface, and then jump to a shooting interface including the target material to capture the image data of the target object. Alternatively, after the user first captures the image data in the shooting interface, the target material is added to the image data.

After the target material and the image data are acquired, the target material and the image data may be directly rendered into the interface, thereby presenting the real image of the target object.

S530: Analyzing the image data to obtain attributes of a plurality of parts of the target object.

The image data may be analyzed through a conventional image analysis algorithm or a machine learning algorithm, thereby obtaining the attributes of the plurality of parts of the target object. Exemplarily, when the target object is a character object, attributes such as the type and color of various parts like the eyes, the nose, the mouth, the eyebrows, the mustache, the hair, etc. of the character object may be analyzed.

S540: Selecting a corresponding virtual part from a preset library based on an attribute of each part and generate a virtual avatar based on the plurality of virtual parts.

After the attributes of the plurality of parts of the target object are determined, the plurality of virtual parts with the same attributes may be selected from the preset library, and a two-dimensional avatar or a quasi-three-dimensional avatar is generated based on the plurality of virtual parts. By generating the virtual avatar based on the attributes of the plurality of parts of the target object, an exclusive virtual avatar similar to the target object may be determined, thereby improving the user experience.

S550: Determining an occlusion relationship between the at least two layers and the virtual avatar.

S560: Rendering, the target material and the virtual avatar based on the occlusion relationship, in response to executing a preset transition effect.

The transition effect may refer to an effect played in the interface during changes of different scenarios. Exemplarily, a transition effect may include emitting particles from the center of the interface towards the periphery or flying particles from one side of the interface to the other side, where the particles may refer to light rays, stars, petals, etc. A default transition effect may be used as the preset transition effect, or a transition effect selected by the user may be used as the preset transition effect.

By playing the preset transition effect, the interface where the target material and the image data are originally rendered is transformed into an interface where the target material and the virtual avatar are rendered, such that an effect of transforming from the real image to the virtual avatar may be presented, thereby enhancing the fun and improving the user experience.

S550 and S560 do not need to have a strict time sequence relationship. For example, in a scenario where the occlusion relationship is determined in real time based on an action performed by the virtual avatar, it may first execute the preset transition effect after determining the virtual avatar, switching to the interface where the target material and the virtual avatar are rendered. Then, the occlusion relationship between the at least two layers and the virtual avatar is determined in real time based on the action of the virtual avatar and rendering is performed, thereby achieving a process of determining the occlusion relationship while performing rendering.

According to the technical solution of embodiments of the present disclosure, thousands of personalized virtual avatars may be created by performing attribute analysis on the plurality of parts of the target object. In addition, before generating a virtual avatar, a real image of a target object may be presented in the interface. After the virtual avatar is generated, the virtual avatar exclusive to the real image may be presented through a transition effect, and the generation of the personalized avatar can improve the user experience. The method for generating an avatar with a three-dimensional effect provided according to this embodiment of the present disclosure and the method for generating an avatar with a three-dimensional effect provided according to the above embodiments belong to the same concept, and for technical details not described in detail in this embodiment, reference may be made to the above embodiments. The same technical features have the same effects in this embodiment and the above embodiments.

This embodiment of the present disclosure may be combined with the plurality of solutions in the method for generating an avatar with a three-dimensional effect provided according to the above embodiments. In the method for generating an avatar with a three-dimensional effect provided according to this embodiment, the process for presenting the virtual avatar with the naked-eye 3D effect in the interface is exemplarily described. In this embodiment, the image collection instruction may be the same as the video collection instruction. After the virtual avatar is generated based on the instruction, the virtual object may also be driven based on the action of the target object. During the driving process, when the virtual avatar is driven to some specific situations, the virtual avatar may be presented with the naked-eye 3D effect.

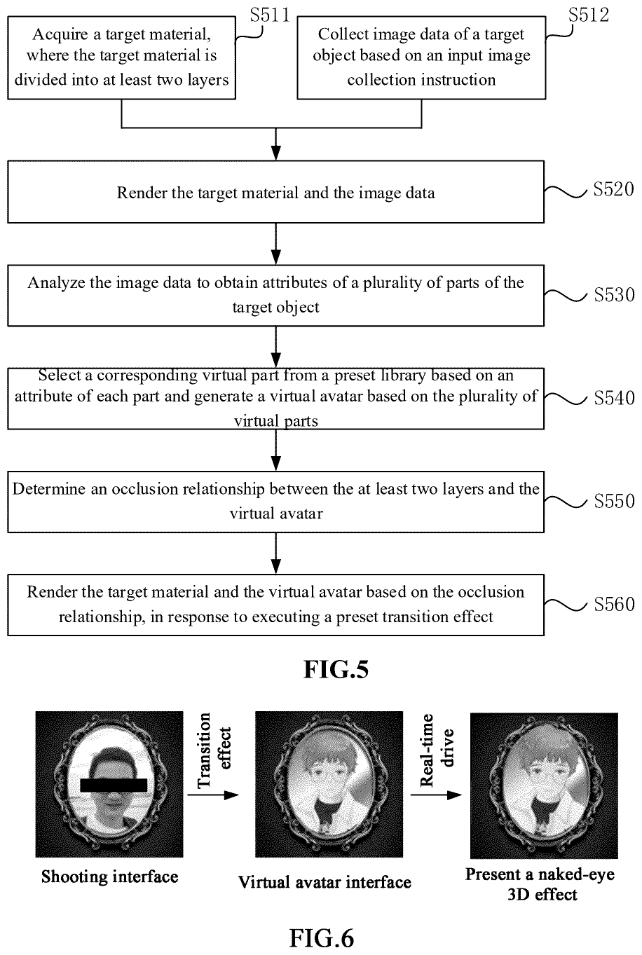

Exemplarily, FIG. 6 is a schematic diagram of a process for presenting a virtual avatar with a naked-eye 3D effect in an interface in a method for generating an avatar with a three-dimensional effect according to an embodiment of the present disclosure, where a target material may be a magic mirror material shown in FIG. 3. Referring to FIG. 6, the process of presenting the virtual avatar with the naked-eye 3D effect in the interface may include following operations.

Firstly, jumping to a shooting interface of the magic mirror material based on an image collection instruction (the same as a video collection instruction) input by a user. In the shooting interface, image data of a character object may be collected, and the magic mirror material and the image data are rendered to present a visual effect of a character looking into the mirror.

Then, the image data may be analyzed to obtain attributes of a plurality of parts of the character object; and a corresponding virtual part is selected from a preset library based on an attribute of each part, and the virtual avatar is generated based on the plurality of virtual parts.

Then, through a cool preset transition effect, the shooting interface where the magic mirror material and the image data are originally rendered is transformed into an interface (which may be referred to as a “virtual avatar interface”) where the magic mirror material and a virtual avatar are rendered. The virtual avatar may be placed in front of an upper layer and behind a lower layer of the magic mirror material.

Finally, video data of the character object may be collected and analyzed to obtain a real-time action of the character object; and the virtual avatar is driven based on the real-time action so as to drive the virtual avatar to perform a corresponding action.

During the process of driving the virtual avatar in real time, when the virtual avatar occludes a part of mirror frame, the virtual avatar interface may present a naked-eye 3D effect, visually creating an illusion that the avatar is emerging from the mirror, which is very vivid and interesting.

According to the technical solution of this embodiment of the present disclosure, the process for presenting the virtual avatar with the naked-eye 3D effect in the interface is exemplarily described. In this embodiment, the image collection instruction may be the same as the video collection instruction. After the virtual avatar is generated based on the instruction, the virtual object may also be driven based on an action of the target object. During the driving process, when the virtual avatar is driven to some specific situations, the virtual avatar may be presented with a naked-eye 3D effect. The method for generating an avatar with a three-dimensional effect provided according to this embodiment of the present disclosure and the method for generating an avatar with a three-dimensional effect provided according to the above embodiments belong to the same concept, and for technical details not described in detail in this embodiment, reference may be made to the above embodiments. The same technical features have the same effects in this embodiment and the above embodiment.

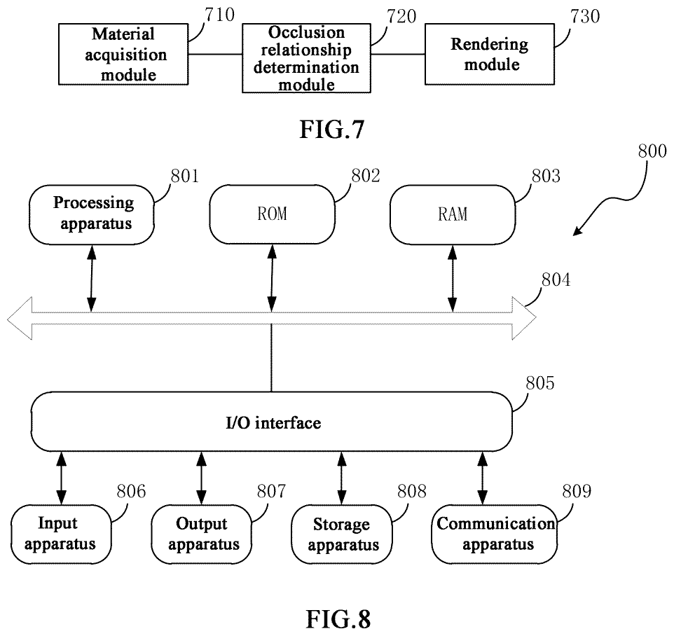

FIG. 7 is a structural schematic diagram of an apparatus for generating an avatar with a three-dimensional effect according to an embodiment of the present disclosure. This embodiment of the present disclosure is suitable for a case of generating a virtual avatar with a 3D effect, such as a case of generating a virtual avatar with a naked-eye 3D effect in real time.

As shown in FIG. 7, the apparatus for generating an avatar with a three-dimensional effect provided according to this embodiment of the present disclosure may include followings:
a material acquisition module 710, configured to acquire a target material, where the target material is divided into at least two layers; an occlusion relationship determination module 720, configured to determine an occlusion relationship between the at least two layers and a virtual avatar; and a rendering module 730, configured to render the target material and the virtual avatar based on the occlusion relationship to generate the virtual avatar with a three-dimensional effect.

In some implementations, the occlusion relationship determination module 720 may be configured to:
determine an occlusion relationship between the at least two layers and the virtual avatar in real time based on an action performed by the virtual avatar.

In some implementations, the apparatus for generating an avatar with a three-dimensional effect may further include:
a drive module, which may be configured to:
collect video data of the target object based on an input video collection instruction; analyze the video data to obtain a real-time action of the target object; and drive the virtual avatar based on the real-time action, so as to cause the virtual avatar to perform a corresponding action.

In some implementations, the occlusion relationship determination module 720 may be further configured to:
determine an occlusion relationship between the at least two layers and the virtual avatar based on preset occlusion relationship identifiers for the at least two layers.

In some implementations, the apparatus for generating an avatar with a three-dimensional effect may further include:
a virtual avatar generation module, which may generate the virtual avatar based on the following method:
collecting image data of the target object based on an input image collection instruction; analyzing the image data to obtain attributes of a plurality of parts of the target object; and selecting a corresponding virtual part from a preset library based on an attribute of each part, and generating the virtual avatar based on the plurality of virtual parts.

In some implementations, the rendering module 730 may be configured to:
render the target material and the image data before generating the virtual avatar; and render the target material and the virtual avatar based on the occlusion relationship, in response to executing a preset transition effect.

In some implementations, the target material includes a frame; and the rendering module 730 may be configured to: render the virtual avatar in front of a part of the frame.

The apparatus for generating an avatar with a three-dimensional effect provided according to this embodiment of the present disclosure may perform the method for generating an avatar with a three-dimensional effect provided by any embodiment of the present disclosure, and has corresponding functional modules and effects for performing the method.

The plurality of units and modules included in the above apparatus are only divided according to functional logics, but are not limited to the above division, as long as the corresponding functions can be achieved; and in addition, the names of the plurality of functional units are only for a convenience of distinguishing each other, and are not intended to limit the scope of protection of the embodiments of the present disclosure.

Referring to FIG. 8 as below, FIG. 8 illustrates a structural schematic diagram of an electronic device (e.g., a terminal device or a server in FIG. 8) 800 suitable for implementing an embodiment of the present disclosure. The terminal device according to this embodiment of the present disclosure may include mobile terminals such as a mobile phone, a notebook computer, a digital radio receiver, a personal digital assistant (PDA), a portable Android device (PAD), a portable media player (PMP), and a vehicle-mounted terminal (e.g., a vehicle-mounted navigation terminal), and fixed terminals such as a digital television (TV) and a desk computer. The terminal device 800 shown in FIG. 8 is merely an example, which should not impose any limitations on functions and application ranges of this embodiment of the present disclosure.

As shown in FIG. 8, the electronic device 800 may include a processing apparatus (e.g., a central processing unit and a graphics processing unit) 801 that may perform various suitable actions and processing based on a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 are connected to one another through a bus 804. An input/output (I/O) interface 805 is also connected to the bus 804.

Typically, the following apparatuses may be connected to the I/O interface 805: an input apparatus 806, including, for example, a touchscreen, a touchpad, a keyboard, a mouse, a camera, a microphone, an accelerometer, and a gyroscope; an output apparatus 807, including, for example, a liquid crystal display (LCD), a speaker, and a vibrator; a storage apparatus 808, including, for example, a magnetic tape and a hard drive; and a communication apparatus 809. The communication apparatus 809 may allow the electronic device 800 to be in wireless or wired communication with another device for data exchange. Although FIG. 8 illustrates the electronic device 800 with various apparatuses, it is not necessary to implement or to have all the shown apparatuses. It may be an alternative to implement or to have more or fewer apparatuses.

According to this embodiment of the present disclosure, the foregoing process described with reference to the flowchart may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication apparatus 809, or installed from the storage apparatus 808, or installed from the ROM 802. The computer program, when executed by the processing apparatus 801, performs the above functions defined in the method for generating an avatar with a three-dimensional effect according to embodiments of the present disclosure.

The electronic device provided by this embodiment of the present disclosure and the method for generating an avatar with a three-dimensional effect provided by the above embodiments belong to the same concept, and for technical details not described in detail in this embodiment, reference may be made to the above embodiments. This embodiment and the above embodiments have the same effects.

An embodiment of the present disclosure provides a computer storage medium, storing a computer program thereon. The computer program, when executed by a processor, implements the method for generating an avatar with a three-dimensional effect provided by the above embodiment.

The computer-readable medium in the present disclosure may be a computer-readable signal medium, or a computer-readable storage medium, or any combination of the two. For example, the computer-readable storage medium may include: electrical, magnetic, optical, electromagnetic, infrared, or semiconductor systems, apparatuses, or devices, or any combination of the above. Examples of the computer-readable storage medium may include, but are not limited to: an electrical connection with one or more wires, a portable computer disk, a hard drive, a random access memory (RAM), a read-only memory (ROM), an erasable programmable read-only memory (EPROM) or a flash, an optical fiber, a portable compact disc read-only memory (CD-ROM), an optical storage device, a magnetic storage device, or any suitable combination of the above. In the present disclosure, the computer-readable storage medium may be any tangible medium including or storing a program, and the program may be used by or in conjunction with an instruction execution system, apparatus, or device. In the present disclosure, the computer-readable signal medium may include a data signal propagated in a baseband or as a part of a carrier, where the data signal carries computer-readable program code. The propagated data signal may take various forms, including an electromagnetic signal, an optical signal, or any suitable combination of the above. The computer-readable signal medium may also be any computer-readable medium other than the computer-readable storage medium. The computer-readable signal medium may send, propagate, or transmit a program for use by or for use in conjunction with the instruction execution system, apparatus, or device. The program code included in the computer-readable medium may be transmitted by any proper medium including: a wire, an optical cable, radio frequency (RF), etc., or any proper combination of the above.

In some implementations, a client and a server may communicate using any currently known or future-developed network protocols such as a hyper text transfer protocol (HTTP), and may also be interconnected with digital data communication in any form or medium (e.g., a communication network). Examples of the communication network include a local area network (LAN), a wide area network (WAN), Internet work (e.g., Internet), a peer-to-peer network (e.g., an ad hoc peer-to-peer network), and any currently known or future-developed networks.

The computer-readable medium may be included in the above electronic device; or may also separately exist without being assembled in the electronic device.

The computer-readable medium carries one or more programs. The one or more programs, when executed by the electronic device, cause the electronic device to: acquire a target material, where the target material is divided into at least two layers; determine an occlusion relationship between the at least two layers and a virtual avatar; and render the target material and the virtual avatar based on the occlusion relationship to generate the virtual avatar with a three-dimensional effect.

The computer program code for performing the operations of the present disclosure may be written in one or more programming languages or a combination thereof. The programming languages include object-oriented programming languages such as Java, Smalltalk, and C++, and further include conventional procedural programming languages such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a LAN or WAN, or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code includes one or more executable instructions for implementing specified logic functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The related units described in the embodiments of the present disclosure may be implemented by software or hardware. The names of the unit and the module do not limit the unit and the module in a certain case.

Herein, the functions described above may be at least partially executed by one or more hardware logic components. For example, exemplary hardware logic components that can be used include, but are not limited to: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may include or store a program for use by or for use in conjunction with the instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatuses, or devices, or any suitable combination of the above content. Examples of the machine-readable storage medium may include: an electrical connection based on one or more wires, a portable computer disk, a hard drive, a RAM, a ROM, an EPROM or a flash, an optical fiber, a CD-ROM, an optical storage device, a magnetic storage device, or any suitable combination of the above content.

According to one or more embodiments of the present disclosure, [Example 1] provides a method for generating an avatar with a three-dimensional effect. The method includes:
acquiring a target material, where the target material is divided into at least two layers;
determining an occlusion relationship between the at least two layers and a virtual avatar; and
rendering the target material and the virtual avatar based on the occlusion relationship to generate the virtual avatar with a three-dimensional effect.

According to one or more embodiments of the present disclosure, [Example 2] provides a method for generating an avatar with a three-dimensional effect, further including:
in some implementations, determining an occlusion relationship between the at least two layers and a virtual avatar includes:
determining the occlusion relationship between the at least two layers and the virtual avatar in real time based on an action performed by the virtual avatar.

According to one or more embodiments of the present disclosure, [Example 3] provides a method for generating an avatar with a three-dimensional effect, further including:
in some implementations, the virtual avatar performs an action based on the following:
collecting video data of the target object based on an input video collection instruction;
analyzing the video data to obtain a real-time action of the target object; and
driving the virtual avatar based on the real-time action to cause the virtual avatar to perform a corresponding action.

According to one or more embodiments of the present disclosure, [Example 4] provides a method for generating an avatar with a three-dimensional effect, further including:
in some implementations, determining an occlusion relationship between the at least two layers and a virtual avatar includes:
determining the occlusion relationship between the at least two layers and the virtual avatar based on preset occlusion relationship identifiers for the at least two layers.

According to one or more embodiments of the present disclosure, [Example 5] provides a method for generating an avatar with a three-dimensional effect, further including:
in some implementations, the virtual avatar is generated based on the following:
collecting image data of a target object based on an input image collection instruction;
analyzing the image data to obtain attributes of a plurality of parts of the target object; and
selecting a corresponding virtual part from a preset library based on an attribute of each part and generating the virtual avatar based on the plurality of virtual parts.

According to one or more embodiments of the present disclosure, [Example 6] provides a method for generating an avatar with a three-dimensional effect, further including:
in some implementations, before the generating the virtual avatar, the method further includes: rendering the target material and the image data; and
rendering the target material and the virtual avatar based on the occlusion relationship includes:
rendering the target material and the virtual avatar based on the occlusion relationship, in response to executing a preset transition effect.

According to one or more embodiments of the present disclosure, [Example 7] provides a method for generating an avatar with a three-dimensional effect, further including:
in some implementations, the target material includes a frame; and
rendering the target material and the virtual avatar based on the occlusion relationship includes: rendering the virtual avatar in front of a part of the frame.

According to one or more embodiments of the present disclosure, [Example 8] provides an apparatus for generating an avatar with a three-dimensional effect, including:
a material acquisition module, configured to acquire a target material, where the target material is divided into at least two layers;
an occlusion relationship determination module, configured to determine an occlusion relationship between the at least two layers and a virtual avatar; and
a rendering module, configured to render the target material and the virtual avatar based on the occlusion relationship to generate the virtual avatar with a three-dimensional effect.

Further, although the plurality of operations are described in a particular order, it should not be understood as requiring these operations to be performed in the shown particular order or in a sequential order. In certain environments, multitasking and parallel processing may be advantageous. Similarly, although several implementation details are included in the above discussion, these implementation details should not be interpreted as limitations on the scope of the present disclosure. Some features described in the context of separate embodiments may also be implemented in combination in a single embodiment. In contrast, various features described in the context of a single embodiment may also be implemented in a plurality of embodiments separately or in any suitable subcombination.

1. A method for generating an avatar with a three-dimensional effect, comprising:
acquiring a target material, wherein the target material is divided into at least two layers;
determining an occlusion relationship between the at least two layers and a virtual avatar; and
rendering the target material and the virtual avatar based on the occlusion relationship to generate the virtual avatar with a three-dimensional effect.

2. The method according to claim 1, wherein determining the occlusion relationship between the at least two layers and the virtual avatar comprises:
determining the occlusion relationship between the at least two layers and the virtual avatar in real time based on an action performed by the virtual avatar.

3. The method according to claim 2, wherein the virtual avatar performs the action based on the following:
collecting video data of a target object based on an input video collection instruction;
analyzing the video data to obtain a real-time action of the target object; and
driving the virtual avatar based on the real-time action to cause the virtual avatar to perform a corresponding action.

4. The method according to claim 1, wherein determining the occlusion relationship between the at least two layers and the virtual avatar comprises:
determining the occlusion relationship between the at least two layers and the virtual avatar based on a preset occlusion relationship identifier for the at least two layers.

5. The method according to claim 1, wherein the virtual avatar is generated based on the following:
collecting image data of a target object based on an input image collection instruction;
analyzing the image data to obtain attributes of a plurality of parts of the target object; and
selecting a corresponding virtual part from a preset library based on an attribute of each part; and generating the virtual avatar based on the plurality of virtual parts.

6. The method according to claim 5, wherein before generating the virtual avatar, the method further comprises: rendering the target material and the image data; and
wherein rendering the target material and the virtual avatar based on the occlusion relationship comprises: rendering the target material and the virtual avatar based on the occlusion relationship, in response to executing a preset transition effect.

7. The method according to claim 1, wherein the target material comprises a frame; and
wherein rendering the target material and the virtual avatar based on the occlusion relationship comprises: rendering the virtual avatar in front of a part of the frame.

8. (canceled)

9. An electronic device, comprising:
at least one processor; and
a storage apparatus, configured to store at least one program,
wherein the at least one program, when executed by the at least one processor, causes the at least one processor to:
acquire a target material, wherein the target material is divided into at least two layers;
determine an occlusion relationship between the at least two layers and a virtual avatar; and
render the target material and the virtual avatar based on the occlusion relationship to generate the virtual avatar with a three-dimensional effect.

10. A non-transitory storage medium comprising computer executable instructions, wherein the computer executable instructions, when executed by a computer processor, cause the computer processor to:
acquire a target material, wherein the target material is divided into at least two layers;
determine an occlusion relationship between the at least two layers and a virtual avatar; and
render the target material and the virtual avatar based on the occlusion relationship to generate the virtual avatar with a three-dimensional effect.

11. (canceled)

12. The electronic device according to claim 9, wherein the at least one program causing the electronic device to determine the occlusion relationship between the at least two layers and the virtual avatar comprises a program causing the electronic device to:
determine the occlusion relationship between the at least two layers and the virtual avatar in real time based on an action performed by the virtual avatar.

13. The electronic device according to claim 12, wherein the virtual avatar performs the action based on the following:
collecting video data of a target object based on an input video collection instruction;
analyzing the video data to obtain a real-time action of the target object; and
driving the virtual avatar based on the real-time action to cause the virtual avatar to perform a corresponding action.

14. The electronic device according to claim 9, wherein the at least one program causing the electronic device to determine the occlusion relationship between the at least two layers and the virtual avatar comprises a program causing the electronic device to:
determine the occlusion relationship between the at least two layers and the virtual avatar based on a preset occlusion relationship identifier for the at least two layers.

15. The electronic device according to claim 9, wherein the virtual avatar is generated based on the following:
collecting image data of a target object based on an input image collection instruction;
analyzing the image data to obtain attributes of a plurality of parts of the target object; and
selecting a corresponding virtual part from a preset library based on an attribute of each part; and generating the virtual avatar based on the plurality of virtual parts.

16. The electronic device according to claim 15, wherein before generating the virtual avatar, the computer executable instructions, when executed by a computer processor, cause the computer processor to render the target material and the image data; and
wherein the at least one program causing the electronic device to render the target material and the virtual avatar based on the occlusion relationship comprises a program causing the electronic device to: render the target material and the virtual avatar based on the occlusion relationship, in response to executing a preset transition effect.

17. The electronic device according to claim 9, wherein the target material comprises a frame; and
wherein the at least one program causing the electronic device to render the target material and the virtual avatar based on the occlusion relationship comprises a program causing the electronic device to: render the virtual avatar in front of a part of the frame.

18. The non-transitory storage medium according to claim 10, wherein the computer executable instructions causing the electronic device to determine the occlusion relationship between the at least two layers and the virtual avatar comprises at least one computer executable instruction causing the electronic device to:
determine the occlusion relationship between the at least two layers and the virtual avatar in real time based on an action performed by the virtual avatar.

19. The non-transitory storage medium according to claim 18, wherein the virtual avatar performs the action based on the following:
collecting video data of a target object based on an input video collection instruction;
analyzing the video data to obtain a real-time action of the target object; and
driving the virtual avatar based on the real-time action to cause the virtual avatar to perform a corresponding action.

20. The non-transitory storage medium according to claim 10, wherein the computer executable instructions causing the electronic device to determine the occlusion relationship between the at least two layers and the virtual avatar comprises at least one computer executable instruction causing the electronic device to:
determine the occlusion relationship between the at least two layers and the virtual avatar based on a preset occlusion relationship identifier for the at least two layers.

21. The non-transitory storage medium according to claim 10, wherein the virtual avatar is generated based on the following:
collecting image data of a target object based on an input image collection instruction;
analyzing the image data to obtain attributes of a plurality of parts of the target object; and
selecting a corresponding virtual part from a preset library based on an attribute of each part; and generating the virtual avatar based on the plurality of virtual parts.

22. The non-transitory storage medium according to claim 10, wherein the target material comprises a frame; and
wherein the computer executable instructions causing the electronic device to render the target material and the virtual avatar based on the occlusion relationship comprises at least one computer executable instruction causing the electronic device to: render the virtual avatar in front of a part of the frame.
